(19) United States
(12) Patent Application Publication
(10) Pub. No.: US 2012/0229433 A1
(43) Pub. Date: Sep. 13, 2012

(54) DUAL FUNCTION CONTROL DEVICE

(75) Inventors: Ole-Johnny Løkkeberg, Hafslundsoy (NO); Trond Helge Edvardsen, Greaker (NO)

(73) Assignee: SEIKO EPSON CORPORATION, Shinjuku-ku (JP)

(21) Appl. No.: 13/476,975

(22) Filed: May 21, 2012

Related U.S. Application Data
(63) Continuation of application No. 11/456,539, filed on Jul. 10, 2006.
(60) Provisional application No. 60/698,653, filed on Jul. 11, 2005.

(51) Int. Cl. G09G 5/00

(52) U.S. Cl. 345/204

(57) ABSTRACT

A display device. In one embodiment, the display device includes a body including an integrated circuit card slot; and a remote device removably storable in the integrated circuit card slot in a docking position. The remote device may be operable to control the display device when in the docking position.

### CROSS REFERENCE TO RELATED APPLICATIONS

This application claims the benefit of U.S. Provisional Application No. 60/698,653, filed Jul. 11, 2005, the entirety of which is incorporated by reference for all purposes.

### BACKGROUND

Display devices are useful in a variety of environments. For example, display devices have become a popular method to present presentations, movies, games, and other content to a variety of audiences, and are used for both personal and business purposes. For use in some environments, display devices are designed to project images onto a viewing surface.

Remote devices may be used to control the display devices. For example, remote devices may enable a user to turn a display device on or off or adjust various image presentation features. For example, a user may be able to adjust the size of a displayed image, the colors of the image, the brightness of the image, the content source, and/or control playback (e.g., play, stop, pause, etc.). Such adjustment of features may be accomplished using the display device inputs or a remote device.

### BRIEF DESCRIPTION OF THE DRAWINGS

FIG. 1 shows a display device according to an embodiment of the present disclosure.

FIG. 2 shows a dual function controller and a corresponding controller dock portion of the display device of FIG. 1.

FIG. 3 shows the dual function controller of FIG. 2 being used to control the display device of FIG. 1.

FIG. 4 shows the dual function controller of FIG. 2 and the display device of FIG. 1.

FIG. 5 shows a dual function controller that can be used with at least two different kinds of display devices.

### DETAILED DESCRIPTION

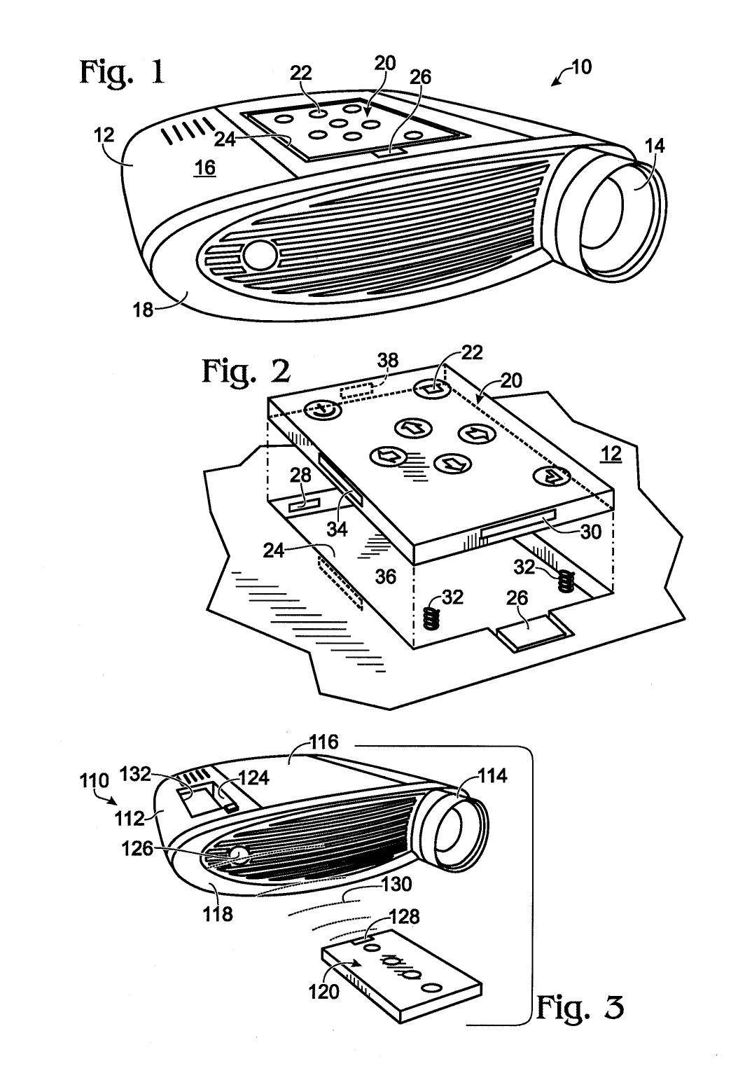

FIG. 1 illustrates a display device, indicated generally at 10. Although shown as a front projection device, display device 10 may be a rear projection device, a combination projection device, an LCD display, a plasma display, and/or other suitable display. The display device may optionally include a computing platform for controlling the display. A front projection device is used as a nonlimiting example of the variety of different display devices that can be used with a dual function control device.

Display device 10 may include a body 12 and a projection lens 14. Although shown in a configuration where lens 14 is offset, it should be appreciated that lens 14 may be disposed in an alternative position based on the configuration of the display device.

Display device 10 may be configured to project an image onto a display surface, such as a screen, a wall, etc. Images, such as, but not limited to, movie images, presentation images, and gaming images may be displayed by the display device. Such display devices may be used in a variety of environments, including home environments, business environments, classroom environments, outdoors, indoors, etc.

In one embodiment of the disclosure, display device 10 may include a dual function control device 20. The dual function control device may include a user input surface, such as a keypad 22. In some embodiments, other user input surfaces may be provided, including touch pads, dials, keys, etc.

Body 12 of display device 10 may include a slot 24 to receive dual function control device 20. Slot 24 may be shaped to correspond to the shape of dual function control device 20. The slot may be an opening which enables the dual function control device to be stored with the body of the display device. In some embodiments, additional structures may be provided to receive dual function control device 20. For example, slot 24 may include drawer elements, lifts, lids, doors, etc.

In some embodiments, slot 24 may be a cavity configured to receive the dual function control device. Slot 24 may be configured such that dual function control device 20 fits flush within the slot. For example, dual function control device may be seated within the slot, such that the top surface of the dual function control device is in substantially the same plane as the surface of the display device. In other embodiments, the dual function control device may be recessed below the receiving surface of the display device, or in even other embodiments, the dual function control device may protrude above the surface of the display device.

Slot 24 may be provided on any suitable side of the display device. In the illustrated embodiment, slot 24 is shown on a top side 16 of the display device; however, it should be appreciated that slot 24 may be on a top surface, a side surface, a front surface, a rear surface or even a bottom surface.

A release device 26 may be provided to enable a user to selectively release the dual function control device from the body of the display device. Release device 26 may be a push button or other lever which may be used to disengage the dual function control device from the seated position within the body of the display device.

The dual function control device can be configured according to a variety of different standards. For example, in some embodiments, dual function control device 20 may be a PC card, PCMCIA card, Express card, Cardbus card, memory card, smart media card, or other type of integrated circuit card. Such an integrated circuit card may be configured to connect the display device via a suitable interface (e.g., a PCMCIA card could connect to a PCMCIA interface).

In such embodiments, slot 24 may be a card slot, such as a PCMCIA card slot. Slot 24 may be configured such that a user may slide the dual function control device (the card) into the slot, transforming the dual function control device (card) into a keyboard for the display device. Thus, when the dual function control device (card) is positioned within slot 24, it may be an operable user input device for the display device. In some embodiments, the dual function control device may provide the primary user inputs or controls for the display device; in other embodiments, the dual function control device may provide a second or auxiliary set of controls. In even other embodiments, the remote may be a “button-free” remote and may be considered a programmable remote or card. The card may be programmable and/or controllable with a computing device, such as a personal computer, a hand-held, etc.

When separated from the display device, the dual function control device can function as a remote control device, which controls the display device from a distance. The remote may be adaptable for a variety of display devices and may be easy to handle, transport and secure. The remote can send and/or receive information to/from the display device via infrared signals, radio frequency signals, or other suitable communication methods.

In some embodiments, the card may replace the keyboard on the display device. Further, in some embodiments, multiple cards may be interchanged—such that the keyboard functions available on the display device may be enhanced or selected by selection of a desired card. Such interchangeable cards may add functions not previously available to a user and/or limit the functions available to a user. For example, a display device may be used in a home environment and a specifically adapted home environment card may be used as the keyboard adding functionality specific to the home environment, including movie settings, television adapter settings, game settings, etc. Further, some cards may be specifically adapted for business settings, such that use of the business setting card may provide functionalities important to a business presenter, including various presentation and graphic formats, etc. Thus, a user may adapt the display device to the desired setting by selecting a card which correlates to the type of use of the display device. In some embodiments, where the cards are interchangeable, a user may be able to change the functionality of a home projector to a business projector and vice versa.

The cards may further be interchanged between various display devices, such as different models and/or manufacturers. The cards may thus operate as a universal remote for the devices. Thus, such a remote card may be a common part for several products. Further, in some embodiments, the cards may be interchangeable with other devices, including cellular phones, personal computers, laptop computers, handheld computers, etc. In addition, in some embodiments, the card may be backward compatible thus making the remote card a replacement remote for exiting display devices.

The card slot may further enable enhancement of the display device, such that other types of cards may be used or inserted into the device. For example, the slot may be configured to receive other cards, such as flash memory cards, TV-tuner cards, network cards, wireless network cards, LAN and WLAN cards, etc.

FIG. 2 further illustrates dual function control device or card 20 released from body 12 of a display device. FIG. 2 is an illustrative figure and it should be appreciated that other structural elements (not shown) may be provided to couple and release dual function control device 20 from the body of the display device.

In one embodiment, slot 24 may include one or more retention mechanisms, illustrated at 28. Retention mechanism 28 may be a retention pin, a latch, a protrusion, detents, etc. In some embodiments, the retention mechanism may be biased such that the dual function control device is removably secured within the slot. For example, a retention pin may include a spring or other suitable biasing mechanism. The retention mechanism may prevent loss of the dual function control device from the body of the display device. In some embodiments, the dual function control device may be considered in an operable storage position when contained within slot 24.

Additional and/or different retention mechanisms may be provided. For example, a receiving or engagement structure 30 may be provided on dual function control device 20. Engagement structure 30 may correspond to release device 26. Release device 26 may removably engage engagement structure 30. In some examples, depression or activation of release device 26 releases dual function control device from slot 24. In some embodiments, activation of release device 26 may function to release the engagement between engagement structure 30 and slot 24.

In some embodiments, springs 32 may be provided in slot 24. Springs 32 may be configured to enable release or ejection of dual function control device 20 from slot 24. Thus, as an example, in some embodiments, dual function control device 20 may be selectively positioned into slot 24. Retention mechanisms 28 and engagement structures 30 may engage the dual function control device temporarily storing and securing the dual function control device within the display device.

Storing the dual function control device within the slot may be a convenient storage location. The access of the slot may prevent loss of the remote. Further, as described in more detail below, the dual function control device may be operable when in the storage position and thus may operate as the display device keypad. In this way, the same controller can be used to locally and remotely control a display device.

A user may selectively eject the dual function control device from slot 24. By activation of release device 26, the dual function control device may be discharged from the storage position. Springs, such as keypad eject springs 32, may displace the dual function control device from the storage position. The released dual function control device may be removed from the display device body and used as a remote control.

Further, some users may remove the dual function control device for security purposes and anti-theft measures. For example, a user may selectively remove the dual function control device from the display device, preventing operation of the projection device (or other suitable display device or remote-controlled device) in the embodiments where the dual function control device functions as both a remote control device and the display device keypad. Without the dual function control device, other unauthorized users may be prevented from operating the display device. In one example, access to operation of a display device disposed in a classroom or other similar setting may be controlled through a remote keypad device. An authorized user may use the dual function control device in the body of the display device or may remove the dual function control device and use it remotely from the display device. During nonuse, the user may selectively retain the dual function control device from the display device; the display device may then have no (or limited) control unit or keypad unit. Thus, unauthorized users may be prevented from operating the display device. Such embodiments, with the removable keypad, may discourage theft of the display device and/or unauthorized use of the display device.

In some embodiments, dual function control device 20 may be battery-powered. For example, dual function control device 20 may be configured with one or more rechargeable batteries. The slot may function as a docking station such that when the dual function control device is positioned within the slot, the battery of the dual function control device may be charged. For illustration, a dual function control device may include a docking port 34 which may electrically couple the dual function control device to a recharger (indicated in dashed lines in FIG. 2) which may be operatively disposed within the display device. For example, the recharger may be disposed adjacent or operatively coupled with the slot such that the dual function control device may be charged when disposed in the slot. The recharger may be powered by the display device, such that when the display device is in operation (or powered) and the dual function control device is stored within the slot, the rechargeable batteries of the dual function control device are recharged.

FIG. 3 provides an illustration of a display device 110 with a dual function control device 120. Display device 110 may include a body 112, a lens 114 and a slot 124 configured to receive a dual function control device 120. The slot may be disposed on any suitable surface of the display device. In the illustrated embodiment, the slot is shown disposed offset from the center of the top side 116 of the display device. The slot may be disposed on another surface, such as front surface 118.

In the illustrated embodiments, dual function control device 120 may be selectively positioned within slot 124 (referred to herein as storage position) or selectively removed or detached from display device (referred to herein as remote position). In some embodiments, dual function control device 120 may be operable as a keypad in both the storage position and the remote position. As a keypad, a user may control operation of the display device.

Dual function control device 120 may include a transmitter 128. Transmitter 128 may be configured to operate with a receiver on the display device. Any suitable communication may be provided for transmitter and receiver, such as infrared (IR) or radio frequency (RF) as examples. For example, the transmitter may be an infrared (IR) transmitting diode configured to communicate with the receiver, which may be an IR receiver. Other communication systems between the transmitter and receiver are possible and within the scope of the disclosure.

The dual function control device may be configured to send operation signals 130 to the display device from transmitter 128 to receiver 126. Thus, when the dual function control device is in the remote position, the dual function control device may transmit signals, such as operation signals, from an IR transmitter to the IR receiver of the display device. It should be appreciated that the IR receiver may be variously positioned on the display device without departing from the scope of the disclosure. Further, it should be appreciated that in some embodiments, the dual function control device may be configured with both a transmitter and a receiver.

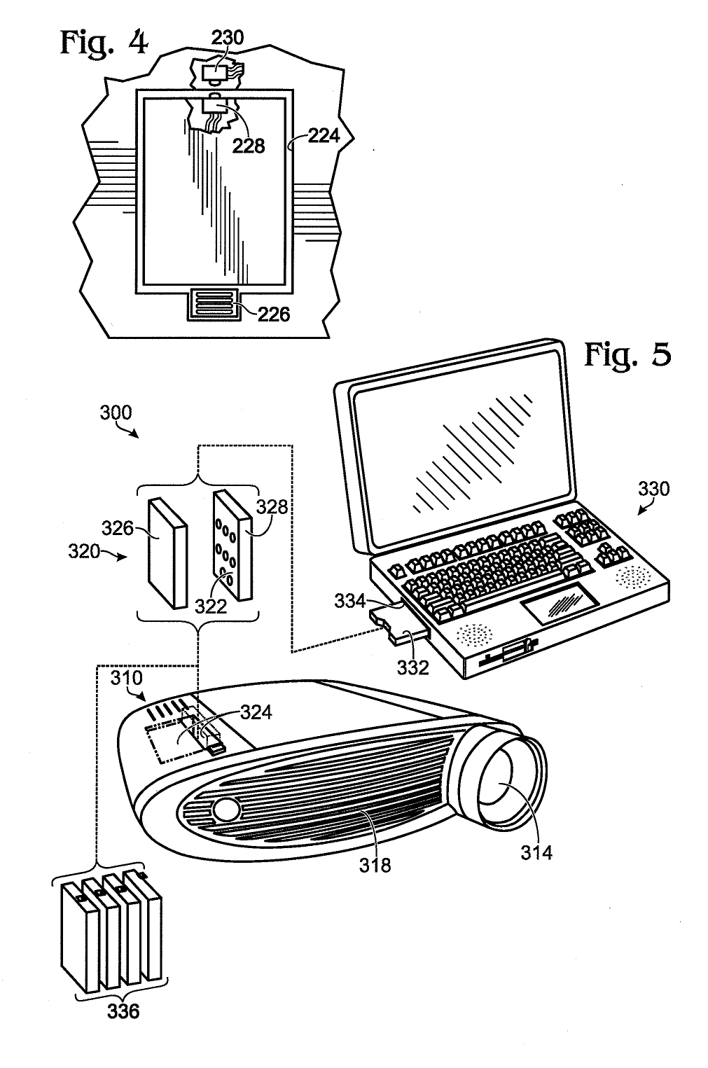

Moreover, in some embodiments, such as in FIG. 4, the dual function control device may be operable in the storage position. For example, the dual function control device may be positioned within a slot 224 of the display device such that the dual function control device is considered to be in a storage position. The dual function control device may include a transmitter, such as IR transmitting diode 228. When in the storage position, the transmitter may be substantially operably aligned with an IR receiver, such as receiver 230. In such a configuration, the dual function control device may transmit operation signals from the transmitter 228 to the receiver 230. Thus, the dual function control device is operable when in the storage or docked position. As such, the dual function control device may operate as an on-board keypad or controller.

In some embodiments, receiver 230 may be the same receiver as the receiver used when dual function control device is being operated in the remote position. In other embodiments, the display device may include two receivers, a first receiver for use when the remote is in the remote position and a second receiver for use when the remote is in the storage position.

It is noted that the incorporation of the IR receiver and the IR transmitting diode for use in the storage position may be a cost-effective solution for interconnecting the dual function control device with the body of the display device. Use of the IR communication may substantially eliminate the failure of worn, dusty or dirty connection points. However, it should be understood that the dual function control device and corresponding display device can additionally or alternatively be configured to communicate using a first mechanism for local communications and a different mechanism for remote communications. In particular, local communications can be made according to the particular technology of the dual function control device (e.g., PCMCIA, Cardbus, Express card, etc.), while remote communications use a different protocol (e.g., IR, RF, Bluetooth, etc.).

FIG. 5 provides an illustration 300 of the operation of a dual function control device in a system including a display device (projection device) 310 and another display device (laptop computer) 330. The projection device may include a body 318 and a projection lens 314. Although shown as a stand-alone projection device, the projection device may be disposed on a network, such that communication may be sent to the projection device from a networked computer.

As shown, projection device 310 may include a slot 324 configured to receive a dual function control device, such as one of the dual function control devices indicated generally at 320. Slot 324 may be a vertical slot or a horizontal slot such as the slot shown in phantom lines. Regardless of the orientation of the slot, a dual function control device may be configured to be received within the slot in a storage or a docking position. In some embodiments, the dual function control device may be operable when in the storage or docking position. In other embodiments, the dual function control device may be operable in both a remote position and a storage position, in just the remote position or in just the storage position.

Dual function control device 320 may be an integrated circuit card, such as a PC card, a PCMCIA card, etc. In some embodiments, the card (such as card 328) may include a keypad, such as indicated at 322. The keypad may be operable by a user in a remote position, or in some embodiments, in an on-board storage position. For example, a user may position the card in slot 324, transforming the card into a keyboard or keypad for a display device. When removed, the same card can be used as a remote control.

In some embodiments, a card, such as card 326, may be a button-free remote which may be controlled by a computing device, such as a laptop computer 330, a handheld computer, a desktop computer, a cellular phone, a game controller, etc. For example, a laptop computer can be used in coordination with the card so that a user interface on the laptop can be used to make control selections, which can be transmitted to a display device via the card (dual function control device).

In some embodiments, select cards may be interchanged, such that a user can select the desired remote or keypad functionalities for the display device.

Additional cards are indicated at 336. Such cards may be selectively inserted in slot 310 and may provide additional functionalities to the display device. For example, cards 336 may be network cards, memory cards, tuner cards, audio cards, game cards, etc. The card slot may thus operate as a universal card slot enabling additional functionalities to be provided to the display device 310.

Although the present exemplary embodiments illustrate the use of a dual function control device with a display device, it should be appreciated that the dual function control device may be used in or with any suitable electrical or electronic device. For example, the dual function control device may be used in other electrical or electronic devices, such as radios, speakers, stereos, robots, vacuums, etc.

Although the present disclosure includes specific embodiments, specific embodiments are not to be considered in a limiting sense, because numerous variations are possible. The foregoing embodiments are illustrative, and no single feature, component, or action is essential to all possible combinations that may be claimed in this or later applications. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “a” or “a first” element or the equivalent thereof. Such claims should be understood to include incorporation of one or more such elements, neither requiring, nor excluding two or more such elements. Further, ordinal numbers, such as first, second, and third, for identified elements or actions are used to distinguish between the elements and actions, and do not indicate a required or limited number of such elements or actions, nor does it indicate a particular position or order of such elements or actions unless otherwise specifically stated. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1-22. (canceled)

23. A display device, comprising:
a docking station for a controller, the docking station comprising:
a docking connector to physically secure the controller; and
a communication interface to communicatively couple the controller to the display device when the docking connector is physically securing the controller; and
a projection module operably linked to the communication interface and configured to receive information from the controller via the communication interface, and to project an image onto a viewing surface based on the information received from the controller.

24. The display device of claim 23, wherein the communication interface further communicatively couples the controller to the display device when the docking connector is not physically securing the controller.

25. The display device of claim 23, wherein the display device is further configured to recharge the controller when the controller is physically secured to the docking connector.

26. The display device of claim 23, wherein the communication interface comprises a receiver, wherein the receiver is operably configured such that the controller transmits operation signals to the receiver.

27. The display device of claim 26, wherein the receiver is an Infrared (IR) receiver.

28. The display device of claim 23, in combination with the controller.

29. The combination of claim 28, wherein the controller is user-programmable.

30. The combination of claim 28, wherein the controller comprises at least one member of the group consisting of an integrated circuit card, a network card, a wireless network card, a memory card, a network card, a tuner card, and a Personal Computer Memory Card International Association (PCMCIA) card.

31. The combination of claim 28, wherein the controller comprises a transmitter and the communication interface comprises a receiver, wherein the receiver is operably configured such that the controller transmits operation signals from the transmitter to the receiver.

32. The combination of claim 31, wherein the transmitter is an Infrared (IR) transmitter and wherein the receiver is an Infrared (IR) receiver.

33. A display device, comprising:
a docking connector to physically secure a controller;
a communication interface to communicatively couple the controller to the display device when the docking connector is physically securing the controller; and
a projection module operably linked to the communication interface and configured to receive information from the controller via the communication interface, and to project an image onto a viewing surface based on the information received from the controller.

34. The display device of claim 33, wherein the communication interface further communicatively couples the controller to the display device when the docking connector is not physically securing the controller.

35. The display device of claim 33, wherein the display device is further configured to recharge the controller when the controller is physically secured to the docking connector.

36. The display device of claim 33, wherein the communication interface comprises a receiver, wherein the receiver is operably configured such that the controller transmits operation signals to the receiver.

37. The display device of claim 36, wherein the receiver is an Infrared (IR) receiver.

38. The display device of claim 33, in combination with the controller.

39. The combination of claim 38, wherein the controller is user-programmable.

40. The combination of claim 38, wherein the controller comprises at least one member of the group consisting of an integrated circuit card, a network card, a wireless network card, a memory card, a network card, a tuner card, and a Personal Computer Memory Card International Association (PCMCIA) card.

41. The combination of claim 38, wherein the controller comprises a transmitter and the communication interface comprises a receiver, wherein the receiver is operably configured such that the controller transmits operation signals from the transmitter to the receiver.

42. The combination of claim 41, wherein the transmitter is an Infrared (IR) transmitter and wherein the receiver is an Infrared (IR) receiver.
